(19) United States
(12) Patent Application Publication
(10) Pub. No.: US 2020/0290718 A1
(43) Pub. Date: Sep. 17, 2020

(54) UNMANNED AERIAL VEHICLE

(71) Applicant: SZ DJI TECHNOLOGY CO., LTD., Shenzhen (CN)

(72) Inventors: Zhenhao ZHOU, Shenzhen (CN); Yihan LIU, Shenzhen (CN); Rongming XIONG, Shenzhen (CN)

(21) Appl. No.: 16/888,051

(22) Filed: May 29, 2020

Related U.S. Application Data
(63) Continuation of application No. PCT/CN2017/115032, filed on Dec. 7, 2017.

(51) Int. Cl. B64C 1/16; B64C 27/22; B64C 1/30

(52) U.S. Cl. CPC B64C 1/16; B64C 27/22; B64C 2201/088; B64C 2201/02; B64C 2201/108; B64C 1/30

(57) ABSTRACT

The present disclosure provides an unmanned aerial vehicle. The unmanned aerial vehicle includes a fuselage, a plurality of rotor propulsion assemblies installed on the fuselage, and a fixed-wing propulsion assembly that is detachably installed on the fuselage. The fixed-wing propulsion assembly is able to rotate relative to the fuselage when the fixed-wing propulsion assembly is installed on the fuselage.

### CROSS-REFERENCE TO RELATED APPLICATION

This application is a continuation application of International Application No. PCT/CN2017/115032, filed on Dec. 7, 2017, the entire content of which is incorporated herein by reference.

### TECHNICAL FIELD

The present disclosure relates to the field of aircraft technology and, more particularly, to an unmanned aerial vehicle.

### BACKGROUND

Common aircrafts are divided into two categories, rotorcraft and fixed-wing aircraft. Rotorcraft may take off and land vertically at a low speed. It does not require much on airport runways, but has a lower flight speed and a shorter flight distance than a fixed-wing aircraft. Fixed-wing aircraft has high take-off and landing speeds, but has high requirements for airport runways. Each of the two aircraft types has its advantages and disadvantages. An aircraft cannot have both of the above described advantages.

### SUMMARY

In accordance with the present disclosure, there is provided an unmanned aerial vehicle. The unmanned aerial vehicle includes a fuselage, a plurality of rotor propulsion assemblies installed on the fuselage, and a fixed-wing propulsion assembly that is detachably installed on the fuselage. The fixed-wing propulsion assembly is able to rotate relative to the fuselage when the fixed-wing propulsion assembly is installed on the fuselage.

### BRIEF DESCRIPTION OF THE DRAWINGS

FIG. 1 is a schematic plan view of an unmanned aerial vehicle according to some embodiments of the present disclosure.

FIG. 2 is a schematic plan view of another unmanned aerial vehicle according to some embodiments of the present disclosure.

FIG. 3 is a schematic plan view of another unmanned aerial vehicle according to some embodiments of the present disclosure.

FIGS. 4-6 are schematic plan views of ailerons of an unmanned aerial vehicle in different states according to some embodiments of the present disclosure.

### DETAILED DESCRIPTION OF THE EMBODIMENTS

Embodiments of the present disclosure will be described in detail hereinafter. Examples of the embodiments are illustrated in the drawings, where the same or similar reference numerals represent the same or similar elements or elements having the same or similar functions throughout the drawings. The embodiments described below with reference to the accompanying drawings are merely for exemplary purposes, and are merely used to explain the present disclosure, but should not be construed as limiting the present disclosure.

In the description of the present disclosure, it is to be understood that the orientation or positional relationships indicated by the terms such as “center”, “longitudinal”, “transverse”, “length”, “width”, “thickness”, “up”, “down”, “front”, “ rear”, “left”, “right”, “vertical”, “horizontal”, “top”, “bottom”, “inside”, “outside”, “clockwise”, or “counterclockwise” are based on the orientation or positional relationship illustrated in the drawings, which are for the convenience of describing the present disclosure and simplifying the description, rather than indicating or implying that the devices or elements referred to must have a specific orientation, or must be organized and operated in a specific orientation. Therefore, such orientation or positional relationships should not be constructed as a limitation to the present disclosure. In addition, the terms “first” and “second” are used for descriptive purposes only and should not be constructed as indicating or implying relative importance or implicitly indicating the number of specified technical features. Therefore, the features defined as “first” and “second” may explicitly or implicitly include at least one of the features. In the description of the present disclosure, the meaning of “a plurality” is at least two, for example, two, three, etc., unless it is specifically defined.

In the description of the present disclosure, it should be noted that the terms “installation”, “connection”, and “fixation” and the like should be interpreted in their broadest meanings unless explicitly stated and limited otherwise. For example, a connection may be a fixed connection, a detachable connection, or an integrated connection; or it may be a mechanical connection, an electrical connection, or an inter-communication; or it may be a direct connection or an indirect connection through an intermediate medium; or it may be an internal communication between two elements or an interaction relationship between two elements, etc. For those of ordinary skill in the art, the specific meanings of the above terms in the present disclosure may be interpreted according to specific applications.

In the present disclosure, unless explicitly stated and defined otherwise, the fact that the first feature is “above” or “below” the second feature may include that the first and second features are in direct contact, and may also include that the first and second features are not in direct contact, but rather connected through other features between the two. Moreover, the fact that the first feature is “above”, “over”, and “beyond” the second feature includes that the first feature is directly above and obliquely above the second feature, or merely indicates that the first feature is higher in altitude than the second feature. The fact that the first feature is “below”, “under”, and “beneath” the second feature includes that the first feature is directly below and obliquely below the second feature, or merely indicates that the first feature is lower in altitude than the second feature.

The following description provides many different embodiments or examples for implementing different structures/organizations of the present disclosure. To simplify the description of the present disclosure, the components and settings of specific examples are described below. Apparently, these examples are merely for exemplary purposes and are not intended to limit the present disclosure. In addition, the present disclosure may repeat reference numerals and/or reference letters in different examples, and such repetition is for the sake of simplicity and clarity, but does not indicate the relationship between the various embodiments and/or settings discussed therein. In addition, the present disclosure provides examples of various specific processes and materials, but those of ordinary skill in the art may be aware of the application of other processes and/or materials applicable in the present disclosure.

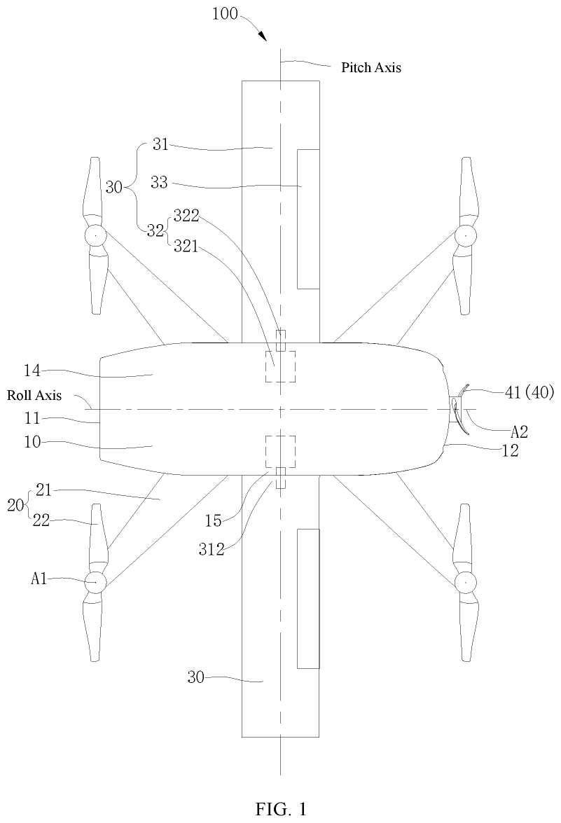

Referring to FIG. 1, an unmanned aerial vehicle (UAV) 100 according to an embodiment of the present disclosure includes a fuselage 10, a plurality of rotor propulsion assemblies 20 and a fixed-wing propulsion assembly 30. The plurality of rotor propulsion assemblies 20 are disposed on the fuselage 10. The fixed-wing propulsion assembly 30 may be detachably installed on the fuselage 10. When the fixed-wing propulsion assembly 30 is installed on the fuselage 10, the fixed-wing propulsion assembly 30 may rotate relative to the fuselage 10.

Specifically, the number of fixed-wing propulsion assembly 30 may be two, four, six, or any even number. When the number of the fixed-wing propulsion assemblies 30 is two, the two fixed-wing propulsion assemblies 30 are installed on opposite sides of the fuselage 10, and the two fixed-wing propulsion assemblies 30 are symmetrically disposed with respect to the fuselage 10. When the number of the fixed-wing propulsion assemblies 30 is four, two fixed-wing propulsion assemblies 30 are installed on one side of the fuselage 10, and the other two fixed-wing propulsion assemblies 30 are installed on the other side of the fuselage 10. The four fixed-wing propulsion assemblies are symmetrically installed with two fixed-wing propulsion assemblies 30 disposed on opposite sides with respect to the fuselage 10. When the number of the fixed-wing propulsion assemblies 30 is six or any even number, the plurality of fixed-wing propulsion assemblies 30 are also symmetrically disposed on opposite sides of the fuselage 10.

When the UAV 100 needs to fly up and down frequently (e.g., when the UAV 100 is flying in a mountain environment), the fixed-wing propulsion assemblies 30 may be detached from the fuselage 10 to avoid a problem of the reduced endurance of the UAV due to the too-heavy weight of the UAV 100 caused by the fixed-wing propulsion assemblies 30.

If the fixed-wing propulsion assemblies 30 are installed on the fuselage 10, when the UAV 100 is in a level flight state, the air flowing through the outer surface of the fixed-wing propulsion assemblies 30 causes the fixed-wing propulsion assemblies 30 to generate a upward lift, which reduces the rotation speed of the rotor propulsion assemblies 20 and ensures that the UAV 100 hovers in the air. When the air flowing through the outer surface of the fixed-wing propulsion assemblies 30 causes the lift generated by the fixed-wing propulsion assemblies 30 to be equal to the gravity of the UAV 100, the rotor propulsion assemblies 20 may even be shut off.

If the fixed-wing propulsion assemblies 30 are installed on the fuselage 10, when the UAV 100 is in a climbing state, the fixed-wing propulsion assemblies 30 may rotate relative to the fuselage 10. In particular, when the UAV 100 climbs vertically, the fixed-wing propulsion assemblies 30 may rotate around the pitch axis to reduce the magnitude of the wind resistance experienced by the fixed-wing propulsion assemblies 30 when the UAV 100 climbs, thereby reducing the energy loss of the UAV 100.

The fixed-wing propulsion assemblies 30 of the UAV 100 according to the embodiments of the present disclosure may be detachably installed on the fuselage 10. Accordingly, the UAV 100 may be selected to install the fixed-wing propulsion assemblies 30 on the fuselage 10 or detach the installed fixed-wing propulsion assemblies 30 from the fuselage 10 according to the flight environment. This allows the UAV 100 to have a larger endurance under different flight environments. Meanwhile, when the UAV 100 is in a level flight mode, the lift generated by the fixed-wing propulsion assemblies 30 may lift the UAV 100, thereby reducing the energy loss of the rotor propulsion assemblies 20. Furthermore, since the fixed-wing propulsion assemblies 30 may be able to rotate relative to the fuselage 10 when the fixed-wing propulsion assemblies 30 are installed on the fuselage 10, when the UAV 100 climbs vertically, the fixed-wing propulsion assemblies 30 may rotate around the pitch axis. This reduces the magnitude of the wind resistance experienced by the fixed-wing propulsion assemblies 30 when the UAV 100 climbs, thereby reducing the energy loss of the UAV 100.

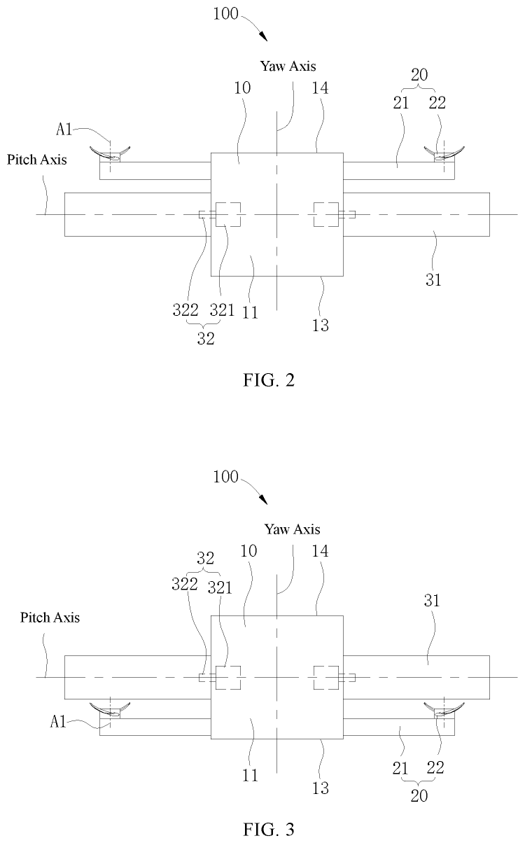

Referring to FIG. 1 and FIG. 2, the UAV 100 according to an embodiment of the present disclosure includes a fuselage 10, a plurality of rotor propulsion assemblies 20 and fixed-wing propulsion assemblies 30.

The fuselage 10 includes a nose 11, a tail 12, an abdomen 13, and a back 14. The tail 12 and the nose 11 are located on opposite sides of the fuselage 10. The nose 11 is located at the front side in the forward direction of the UAV 100, while the tail 12 is located at the rear side in the forward direction of the UAV 100. The abdomen 13 is located under the fuselage 10, and the back 14 and the abdomen 13 are located on opposite sides of the fuselage 10. During the normal flight of the UAV 100, the abdomen 13 is closer to the ground than the back 14. A plurality of mounting ends 15 are symmetrically disposed on two sides of the fuselage 10.

Each rotor propulsion assembly 20 includes a connection arm 21 and a rotor blade 22. One end of the connection arm 21 is fixedly connected to the fuselage 10, and the other end of the connection arm 21 includes a rotor blade 22 installed therein. The center axis of the rotor blade 22 may be consistent with the up and down moving direction of the UAV 100. Specifically, the connection arms 21 extend outward from the side surface of the fuselage 10, and a plurality of connection arms 21 are symmetrically disposed around the center position of the fuselage 10. When the UAV 100 climbs vertically, the central axis Al of the rotor blade 22 is consistent with the climbing direction of the UAV 100.

The number of the fixed-wing propulsion assemblies 30 is a plurality, and the plurality of fixed-wing propulsion assemblies 30 are symmetrically installed on two sides of the fuselage 10. A fixed-wing propulsion assembly 30 includes a fixed-wing main body 31 and a driving motor 32. The fixed-wing main body 31 includes a connection end 312. The connection end 312 may be detachably mounted on a mounting end 15, and the connection end 312 may rotate relative to the mounting end 15 after being mounted on the mounting end 15. The driving motor 32 includes a stator 321 and a rotor 322. The stator 321 is fixed on the mounting end 15. The rotor 322 is connected to the connection end 312. When the driving motor 32 drives the rotor 322 to rotate relative to the stator 321, the rotor 322 may drive the fixed-wing main body 31 to rotate relative to the fuselage 10. In the disclosed embodiments, the stator 321 may also be fixed on a connection end 312, and the rotor 322 is connected to the mounting end 15. When the driving motor 32 drives the rotor 322 to rotate relative to the stator 321, the stator 321 may drive the fixed-wing main body 31 to rotate relative to the fuselage 10.

A connection end 312 and a mounting end 15 may be connected together in a snap-fit manner. Specifically, the mounting end 15 includes a first engaging member, the connection end 312 includes a second engaging member. After the engagement through the snap-fit, the connection end 312 and the mounting end 15 may be able to rotate relative to each other. In some embodiments, the mounting end 15 further includes a first limiter, and the connection end 312 further includes a second limiter. The first limiter and the second limiter cooperate with each other to limit the maximum rotation angle between the fuselage 10 and the fixed-wing propulsion assemblies 30. In some embodiments, the mounting end 15 further includes a first thread, and the connection end 312 further includes a second thread. The first thread and the second thread are screwed to each other to connect the connection end 312 with the mounting end 15.

When the UAV 100 needs to fly up and down frequently (e.g., when the UAV 100 is flying in a mountain environment), the fixed-wing propulsion assemblies 30 may be detached from the fuselage 10 to avoid a problem of the reduced endurance of the UAV due to the too-heavy weight of the UAV 100 caused by the fixed-wing propulsion assemblies 30.

If the fixed-wing propulsion assemblies 30 are installed on the fuselage 10, when the UAV 100 is in a level flight state, the air flowing through the outer surface of the fixed-wing propulsion assemblies 30 causes the fixed-wing propulsion assemblies 30 to generate a upward lift, which then reduces the rotation speed of the rotor propulsion assemblies 20 and ensures that the UAV 100 may hover in the air. When the air flowing through the outer surface of the fixed-wing propulsion assemblies 30 causes the lift generated by the fixed-wing propulsion assemblies 30 to be equal to the gravity of the UAV 100, the rotor propulsion assemblies 20 may also be shut off.

If the fixed-wing propulsion assemblies 30 are installed on the fuselage 10, when the UAV 100 is in a climbing state, the fixed-wing propulsion assemblies 30 may rotate relative to the fuselage 10. In particular, when the UAV 100 climbs vertically, the fixed-wing propulsion assemblies 30 may rotate around the pitch axis to reduce the magnitude of the wind resistance experienced by the fixed-wing propulsion assemblies 30 when the UAV 100 climbs, thereby reducing the energy loss of the UAV 100.

The fixed-wing propulsion assemblies 30 of the UAV 100 according to the embodiments of the present disclosure may be detachably installed on the fuselage 10. Accordingly, based on the flight environment, the UAV 100 may be selected to install the fixed-wing propulsion assemblies 30 on the fuselage 10, or detach the installed fixed-wing propulsion assemblies 30 from the fuselage 10, which then allows the UAV 100 to have a larger endurance under different flight environments. Meanwhile, when the UAV 100 is in a level flight mode, the lift generated by the fixed-wing propulsion assemblies 30 may lift the UAV 100, thereby reducing the energy loss of the rotor propulsion assemblies 20. Furthermore, since the fixed-wing propulsion assemblies 30 may be able to rotate relative to the fuselage 10 when the fixed-wing propulsion assemblies 30 are installed on the fuselage 10, when the UAV 100 climbs vertically, the fixed-wing propulsion assemblies 30 may rotate around the pitch axis. This reduces the magnitude of the wind resistance experienced by the fixed-wing propulsion assemblies 30 when the UAV 100 climbs, thereby reducing the energy loss of the UAV 100.

Referring to FIG. 1, in some embodiments, in the nose 11 to tail 12 direction of the fuselage 10, that is, in the roll axis direction of the UAV 100, the plurality of rotor propulsion assemblies 20 are disposed alternatively and spaced apart from the fixed-wing propulsion assemblies 30.

Specifically, the number of the fixed-wing propulsion assemblies 30 may be one or more. When the rotor blades 22 rotate, the airflow generated by the rotor blades 22 may interfere with the fixed-wing main body 31 and cause the flight of the UAV 100 to be unstable. In the disclosed embodiments, the plurality of rotor propulsion assemblies 20 and the fixed-wing propulsion assemblies 30 are alternatively disposed and spaced apart from each other, thereby preventing the airflow generated by the rotor propulsion assemblies 20 from interfering with the fixed-wing propulsion assemblies 30, thereby making the flight of the UAV 100 more stable.

Referring to FIG. 1, in some embodiments, in the nose 11 to tail 12 direction of the fuselage 10, that is, in the roll axis direction of the UAV 100, the plurality of rotor propulsion assemblies 20 are alternatively disposed and spaced apart from the wing propulsion assemblies 30. The plurality of rotor propulsion assemblies 20 are symmetrically distributed around the center of the fuselage 10. The plurality of rotor propulsion assemblies 20 are disposed on two sides of the fixed-wing propulsion assemblies 30 near the nose 11 and the tail 12.

Specifically, the fixed-wing propulsion assemblies 30 are installed at a position closer to the center of the fuselage 10, where the center of the fuselage 10 may be the center of gravity of the fuselage 10. By disposing the fixed-wing propulsion assemblies 30 closer to the center of the fuselage 10, the UAV 100 does not generate a forward bending moment or a backward bending moment under the action of the fixed-wing propulsion assemblies 30, thereby balancing the UAV 100 after the fixed-wing propulsion assemblies 30 are installed on the fuselage 10. The plurality of rotor propulsion assemblies 20 are symmetrically distributed around the center of the fuselage 10, which is convenient for controlling the plurality of rotor propulsion assemblies 20 to coordinately act to control the UAV 100 to complete various flight modes (e.g., climb mode, dive mode, forward flight mode, rear flight mode, side flight mode).

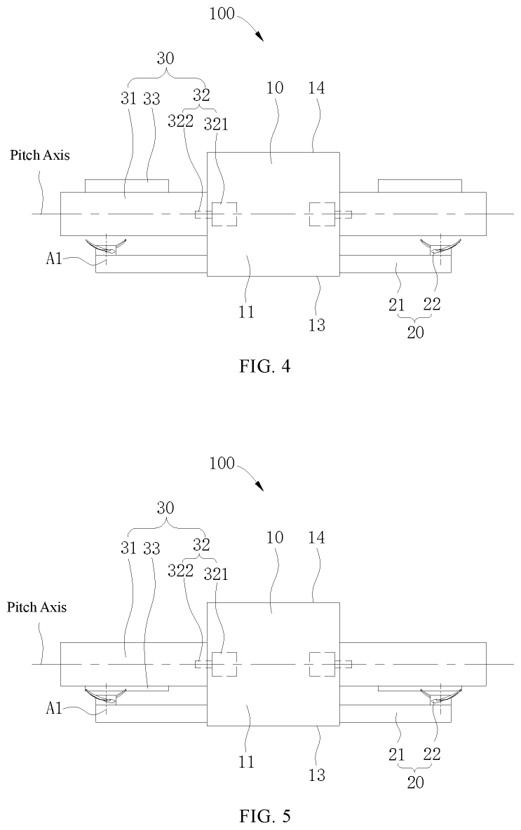

Referring to FIG. 1 and FIG. 2, in some embodiments, the plurality of rotor propulsion assemblies 20 are disposed above the fixed-wing propulsion assemblies 30 in an abdomen 13 to back 14 direction of the fuselage 10 (as shown in FIG. 2). Optionally, the plurality of rotor propulsion assemblies 20 are disposed obliquely above (not directly above) the fixed-wing propulsion assemblies 30. That is, in the roll axis direction of the UAV 100, the plurality of rotor propulsion assemblies 20 and the fixed-wing propulsion assemblies 30 are spaced apart and the plurality of rotor propulsion assemblies 20 are disposed above the fixed-wing propulsion assemblies 30. In some embodiments, the plurality of rotor propulsion assemblies 20 may also be disposed below the fixed-wing propulsion assemblies 30 (as shown in FIG. 3). Optionally, the plurality of rotor propulsion assemblies 20 are disposed obliquely below (not directly below) the fixed-wing propulsion assemblies 30. That is, in the roll axis direction of the UAV 100, the plurality of rotor propulsion assemblies 20 are spaced apart from the fixed-wing propulsion assemblies 30 and the plurality of rotor propulsion assemblies 20 are disposed under the fixed-wing propulsion assemblies 30. Alternatively, some of the rotor propulsion assemblies are disposed below the fixed-wing propulsion assemblies 30, while the remaining of the rotor propulsion assemblies 20 are disposed above the fixed-wing propulsion assemblies 30.

Referring to FIG. 1, in some embodiments, the UAV 100 further includes a propeller propulsion assembly 40. The propeller propulsion assembly 40 is installed on the tail 12 of the fuselage 10. By installing the propeller propulsion assembly 40 on the tail 12, it may be used to propel the UAV 100 forward.

When the UAV 100 is in the climbing, diving, or hovering state, the rotor propulsion assemblies 20 are turned on, which provides the lift for the UAV 100. At this moment, the propeller propulsion assembly 40 is turned off. When the UAV 100 is in a flying forward state, the propeller propulsion assembly 40 is turned on, which provides the forward propulsion for the UAV 100. The rotational speed of the rotor propulsion assemblies 20 in the flying forward state is lower than that in the hovering state. At this moment, the lift of the UAV 100 is provided by the rotor propulsion assemblies 20 and the fixed-wing propulsion assemblies 30 together. Alternatively, the rotor propulsion assemblies 20 may be turned off, and the lift of the UAV 100 is provided by the fixed-wing propulsion assemblies 30. In some embodiments, the propeller propulsion assembly 40 may be installed on the nose 11 of the fuselage 10. By installing the propeller propulsion assembly 40 on the nose 11, it may be used to pull the UAV 100 forward. Alternatively, the number of the propeller propulsion assemblies 40 is two, and the two propeller propulsion assemblies 40 are installed on the nose 11 and the tail 12, respectively.

Referring to FIG. 1, in some embodiments, the UAV 100 further includes a propeller propulsion assembly 40, and the propeller propulsion assembly 40 is installed on the nose 11 or the tail 12 of the fuselage 10. The propeller propulsion assembly 40 includes a propeller 41, and the centerline axis A2 of the propeller 41 is consistent with the forward direction of the UAV 100. When the propeller propulsion assembly 40 is installed on the tail 12, it facilitates the propeller propulsion assembly 40 to push the UAV 100 forward. When the propeller propulsion assembly 40 is installed on the nose 11, it facilitates the propeller propulsion assembly 40 to pull the UAV 100 forward.

Referring to FIG. 1, in some embodiments, a fixed-wing propulsion assembly 30 includes a fixed-wing main body 31 and an aileron 33 disposed on the fixed-wing main body 31. The aileron 33 is disposed on the side of the fixed-wing main body 31 near the tail 12. Specifically, each fixed-wing propulsion assembly 30 includes at least one aileron 33. When the number of the fixed-wing propulsion assemblies 30 is a plurality and the plurality of fixed-wing propulsion assemblies 30 are symmetrically disposed on two sides of the fuselage 10, a plurality of ailerons 33 of the plurality of fixed-wing propulsion assemblies 30 are also disposed symmetrically with respect to the fuselage 10.

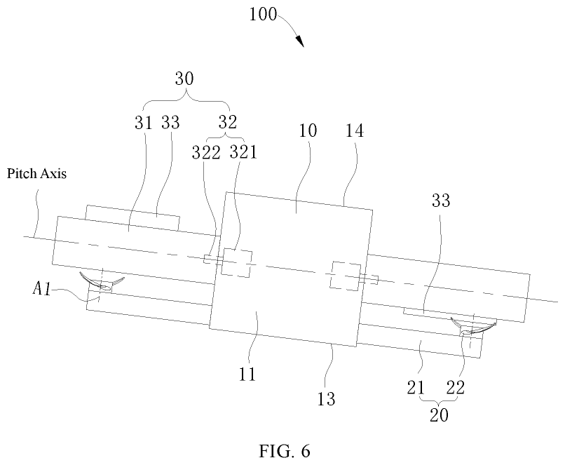

Referring to FIG. 4, when the UAV 100 is flying forward, if the plurality of ailerons 33 are turned toward the back 14 side of the fuselage 10, the air velocity will increase and the air pressure will decrease on the side of the fixed-wing main body 31 corresponding to the back 14. This then increases the lift generated by the fixed-wing main body 31, so that the UAV 100 may climb without increasing the rotation speed of the rotor propulsion assemblies 20, thereby reducing the energy loss of the UAV 100.

Referring to FIG. 5, when the UAV 100 is flying forward, if the plurality of ailerons 33 are turned toward the abdomen 13 side of the fuselage 10, the air velocity will increase and the air pressure will decrease on the side of the fixed-wing main body 31 corresponding to the abdomen 13. This reduces the lift generated by the fixed-wing main body 31, thereby lowering the altitude of the UAV 100.

Referring to FIG. 6, when the UAV 100 is flying forward, if the aileron 33 on one side of the fuselage 10 is turned toward the back 14 side of the fuselage 10, and the aileron 33 on the other side of the fuselage 10 is turned toward the abdomen 13 side of the fuselage 10, the lift generated by the aileron 33 turned toward the back 14 side is larger than the lift generated by the aileron 33 turned toward the abdomen 13 side, which then allows the UAV 100 to flip toward one side of the fuselage 10.

In the description of this specification, the descriptions for the reference terms “certain embodiments”, “one embodiment”, “some embodiments”, “exemplary embodiments”, “examples”, “specific examples”, or “some examples”, etc., mean that the specific features, structures, materials, or characteristics described in conjunction with the embodiments or examples are included in at least one embodiment or example of the present disclosure. In this specification, the schematic expressions of the above terms do not necessarily refer to the same embodiment or example. Furthermore, the described specific features, structures, materials, or characteristics may be combined in any suitable manner in any one or more embodiments or examples.

Although the embodiments of the present disclosure have been illustrated and described above, it is to be understood that the above embodiments are merely for exemplary purposes and should not be construed as limiting the present disclosure. Those skilled in the art may change, modify, replace, or alter the above embodiments within the scope of the present disclosure, which is defined by the appended claims and their equivalents.

What is claimed is:

1. An unmanned aerial vehicle, comprising:
a fuselage;
a plurality of rotor propulsion assemblies installed on the fuselage; and
a fixed-wing propulsion assembly detachably installed on the fuselage, wherein the fixed-wing propulsion assembly is able to rotate relative to the fuselage when the fixed-wing propulsion assembly is installed on the fuselage.

2. The unmanned aerial vehicle according to claim 1, wherein the fuselage is provided with a mounting end, and the fixed-wing propulsion assembly includes a connection end, the connection end is mounted on the mounting end and is able to rotate relative to the mounting end, and the connection end and the mounting end are able to get connected together through a snap-fit or screwing.

3. The unmanned aerial vehicle according to claim 2, wherein the fixed-wing propulsion assembly includes a driving motor, and
a stator of the driving motor is fixed at the mounting end, and a rotor of the driving motor is connected to the connection end; or
the stator of the driving motor is fixed at the connection end, and the rotor of the driving motor is connected to the mounting end.

4. The unmanned aerial vehicle according to claim 1, wherein the number of the fixed-wing propulsion assembly is a plurality, and the plurality of the fixed-wing propulsion assemblies are symmetrically installed on two sides of the fuselage.

5. The unmanned aerial vehicle according to claim 1, wherein a rotor propulsion assembly includes a connection arm and a rotor blade, one end of the connection arm is connected to the fuselage, and the other end of the connection arm includes an installed rotor blade, and a center axis of the rotor blade is consistent with an up and down moving direction of the unmanned aerial vehicle.

6. The unmanned aerial vehicle according to claim 1, wherein the plurality of the rotor propulsion assemblies are spaced apart from the fixed-wing propulsion assembly in a direction from a nose to a tail of the fuselage.

7. The unmanned aerial vehicle according to claim 6, wherein the plurality of the rotor propulsion assemblies are symmetrically distributed around a center of the fuselage, and the plurality of the rotor propulsion assemblies are disposed on two sides of the fixed-wing propulsion assembly close to the nose and the tail.

8. The unmanned aerial vehicle according to claim 1, wherein, in a direction from an abdomen to a back of the fuselage,
the plurality of the rotor propulsion assemblies are disposed above the fixed-wing propulsion assembly; or
the plurality of the rotor propulsion assemblies are disposed below the fixed-wing propulsion assembly.

9. The unmanned aerial vehicle according to claim 1, wherein the unmanned aerial vehicle further includes a propeller propulsion assembly installed on a nose or a tail of the fuselage.

10. The unmanned aerial vehicle according to claim 9, wherein the propeller propulsion assembly includes a propeller, and a centerline axis of the propeller is consistent with a forward direction of the unmanned aerial vehicle.

11. The unmanned aerial vehicle according to claim 1, wherein at least one aileron is disposed on a fixed-wing main body of the fixed-wing propulsion assembly.

12. The unmanned aerial vehicle according to claim 11, wherein the at least one aileron is disposed on a side of the fixed-wing main body of the fixed-wing propulsion assembly near a tail.

13. The unmanned aerial vehicle according to claim 1, wherein the fixed-wing propulsion assembly includes at least one aileron.

14. The unmanned aerial vehicle according to claim 4, wherein, when the number of the fixed-wing propulsion assembly is a plurality and the plurality of fixed-wing propulsion assemblies are symmetrically disposed on two sides of the fuselage, a plurality of ailerons associated with the plurality of fixed-wing propulsion assemblies are also disposed symmetrically with respect to the fuselage.

15. The unmanned aerial vehicle according to claim 11, wherein, when the unmanned aerial vehicle is flying forward, if the at least one aileron is turned toward a back side of the fuselage, an air velocity will increase and an air pressure will decrease on a side of the fixed-wing main body of the fixed-wing propulsion assembly corresponding to a back of the fuselage, so that the unmanned aerial vehicle may climb without increasing a rotation speed of the plurality of rotor propulsion assemblies.

16. The unmanned aerial vehicle according to claim 11, wherein, when the unmanned aerial vehicle is flying forward, if the at least one aileron is turned toward an abdomen side of the fuselage, an air velocity will increase and an air pressure will decrease on a side of the fixed-wing main body of the fixed-wing propulsion assembly corresponding to an abdomen of the fuselage, to reduce a lift generated by the fixed-wing main body, thereby lowering an altitude of the unmanned aerial vehicle.

17. A method for controlling an unmanned aerial vehicle, wherein:
the unmanned aerial vehicle comprises:
a fuselage,
a plurality of rotor propulsion assemblies installed on the fuselage,
a fixed-wing propulsion assembly detachably installed on the fuselage, wherein the fixed-wing propulsion assembly is able to rotate relative to the fuselage when the fixed-wing propulsion assembly is installed on the fuselage, and
at least one aileron disposed on a fixed-wing main body of the fixed-wing propulsion assembly; and
the method comprises:
when the unmanned aerial vehicle is flying forward, turning the at least one aileron toward a back side of the fuselage, to allow an air velocity to increase and an air pressure to decrease on a side of the fixed-wing main body corresponding to a back of the fuselage, so that the unmanned aerial vehicle may climb without increasing a rotation speed of the plurality of rotor propulsion assemblies.

18. The method according to claim 17, wherein the fuselage is provided with a mounting end, and the fixed-wing propulsion assembly includes a connection end, the connection end is mounted on the mounting end and is able to rotate relative to the mounting end, and the connection end and the mounting end are able to get connected together through a snap-fit or screwing.

19. A method for controlling an unmanned aerial vehicle, wherein:
the unmanned aerial vehicle comprises:
a fuselage,
a plurality of rotor propulsion assemblies installed on the fuselage,
a fixed-wing propulsion assembly detachably installed on the fuselage, wherein the fixed-wing propulsion assembly is able to rotate relative to the fuselage when the fixed-wing propulsion assembly is installed on the fuselage, and
at least one aileron disposed on a fixed-wing main body of the fixed-wing propulsion assembly; and
the method comprises:
when the unmanned aerial vehicle is flying forward, turning the at least one aileron toward an abdomen side of the fuselage, to allow an air velocity to increase and an air pressure to decrease on a side of the fixed-wing main body corresponding to an abdomen of the fuselage, so as to reduce a lift generated by the fixed-wing main body, thereby lowering an altitude of the unmanned aerial vehicle.

20. The method according to claim 19, wherein the fuselage is provided with a mounting end, and the fixed-wing propulsion assembly includes a connection end, the connection end is mounted on the mounting end and is able to rotate relative to the mounting end, and the connection end and the mounting end are able to get connected together through a snap-fit or screwing.
